(19) United States
(12) Patent Application Publication
(10) Pub. No.: US 2013/0220971 A1
(43) Pub. Date: Aug. 29, 2013

(54) METHOD FOR MANUFACTURING A MULTILAYER STRUCTURE WITH A LATERAL PATTERN FOR APPLICATION IN THE XUV WAVELENGTH RANGE, AND BF AND LMAG STRUCTURES MANUFACTURED ACCORDING TO THIS METHOD

(71) Applicants: Frederik Bijkerk, Bosch en Duin (NL); Wilfred Gerard Van Der Wiel, ME Enschede (NL); Robert Van Der Meer, KM Hengelo (OV) (NL); Petronella Emerentiana Hegeman, EK Borne (NL)

(72) Inventors: Frederik Bijkerk, Bosch en Duin (NL); Wilfred Gerard Van Der Wiel, ME Enschede (NL); Robert Van Der Meer, KM Hengelo (OV) (NL); Petronella Emerentiana Hegeman, EK Borne (NL)

(73) Assignee: PANALYTICAL B.V., EA Almelo (NL)

(21) Appl. No.: 13/515,127

(22) PCT Filed: Dec. 8, 2010
(86) PCT No.: PCT/NL2010/050832

§ 371 Date: May 9, 2013

(30) Foreign Application Priority Data
Dec. 11, 2009 (NL) 2003950

(51) Int. Cl. G02B 6/34

(52) U.S. Cl. CPC G02B 6/34
USPC 216/24; 427/162; 427/558

(57) ABSTRACT

Method for manufacturing a multilayer structure with a lateral pattern, in particular of an optical grating for application in an optical device for electromagnetic radiation with a wavelength in the wavelength range between 0.1 nm and 100 nm, comprising the steps of (i) providing a multilayer structure, and (ii) arranging a lateral three-dimensional pattern in the multilayer structure, wherein step (ii) of arranging the lateral pattern is performed by means of a method for nano-imprint lithography (NIL), and BF and LMAG structures manufactured according to this method.

The invention relates to a method for manufacturing a multilayer structure with a lateral pattern, in particular of an optical grating for application in an optical device for electromagnetic radiation with a wavelength in the wavelength range between 0.1 nm and 100 nm, comprising the steps of (i) providing a multilayer structure, and (ii) arranging a lateral pattern in the multilayer structure.

The wavelength range between 0.1 nm and 10 μm comprises the hard X-ray range (wavelength between 0.1 nm and 10 nm) and the so-called XUV range (wavelength between 10 nm and 100 nm) which includes the range around a wavelength of 13.5 nm, referred to in literature as EUV radiation, as well as radiation in the soft X-ray range of the electromagnetic spectrum.

Such an optical grating is for instance applied in the production of semiconductor circuits within the technical field of nanolithography.

A particular example of such an optical grating is a so-called nano-Bragg-Fresnel (BF) structure, which forms a combination of a reflective optical element, a Bragg structure, and a diffractive optical element, a Fresnel structure.

Another example of such an optical grating is a lamellar multilayer amplitude grating (LMAG) structure, which is applied in a monochromator for spectroscopic analysis in the XUV wavelength range.

It is known to manufacture BF structures and LMAG structures according to per se known methods, such as electron beam (EB) lithography and deep ultraviolet (DUV) lithography.

The known methods have serious drawbacks in the serial production of large arrays of nanostructures with dimensions on nanometre scale.

EB lithography is relatively expensive and time-consuming and, as a consequence of so-called proximity effects and parameter drift during exposure to the electron beam, can produce results with a poor reproducibility.

DUV photolithography encounters problems of a fundamental nature at resolution levels in the structure to be manufactured of lower than 50 nm. Furthermore, DUV photolithography is only cost-effective in mass production on very large scale.

Both methods have the drawback that the width of a lamella in a periodic lateral pattern amounts to a minimum of several hundred nanometres, while the period amounts to at least one μm.

It is an object of the invention to propose a method for manufacturing a multilayer structure with characteristic dimensions smaller than 50 nm in rapid, reproducible and cost-effective manner.

It is a particular object to propose such a method for manufacturing a nano-BF structure or a nano-LMAG structure.

These objectives are realized, and other advantages gained, with a method of the type stated in the preamble, wherein according to the invention step (ii) of arranging the lateral pattern is performed by means of a method for nano-imprint lithography (NIL).

The method for nano-imprint lithography (NIL) for instance comprises at least the steps of (a) providing a stamp with a stamp pattern corresponding to the lateral three-dimensional pattern to be arranged, (b) applying a layer of a curable resist material to the multilayer structure, (c) arranging the stamp pattern, using the stamp, in the layer of resist material applied according to step (b), and curing this material, and (d) removing from the multilayer structure material not, or at least substantially not covered by resist material in accordance with the stamp pattern while forming the lateral three-dimensional pattern in the multilayer structure.

In an embodiment a metal layer is deposited, prior to step (b) or following step (c), onto the multilayer structure which is flat or provided with a lateral pattern, and is subsequently applied as etching mask.

The stamp to be provided according to the invention is for instance manufactured from Si or SiO₂ (quartz), in which the stamp pattern is arranged in accordance with a per se known method, for instance by means of electron beam lithography (EBL) or laser interference lithography.

After removal of material from the multilayer structure and forming of the lateral three-dimensional pattern in the multilayer structure in step (d), the layer of resist material is removed using a solvent, and the multilayer structure provided with a three-dimensional pattern can be subjected to a subsequent process step.

The removal of material in step (d) is for instance performed in accordance with a method for reactive ion etching (RIE), by means of an inductively coupled plasma (ICP) or according to a Bosch-type etching method.

Depending on the specifications of the multilayer structure to be manufactured, according to embodiments of the method the lateral three-dimensional pattern to be formed in the multilayer structure in step (d) is given a parallel, widening wedge-shaped or narrowing wedge-shaped form from the surface of the multilayer structure.

The resist material to be applied according to step (b) is preferably a UV-curable plastic which in cured state has a relatively low viscosity, for instance a polymethyl methacrylate (PMMA).

Depending on the specifications of the multilayer structure to be manufactured, in an embodiment of a method according to the invention step (ii) of arranging the lateral pattern is followed by step (iii) of applying a cover layer over the three-dimensional pattern.

The invention also relates to a multilayer structure with a periodic lateral pattern manufactured according to the above described method, wherein the period is smaller than 1 μm.

The invention also relates to a BF structure manufactured according to the above described method, wherein the multilayer structure comprises a stack of layers of a first material from a first group comprising carbon (C) and silicon (Si) and of layers of a second material from a second group comprising the materials from the groups of transition elements from the fourth, fifth and sixth period of the periodic system of elements.

In an embodiment the layers of the second material are selected from the group of transition elements comprising cobalt (Co), nickel (Ni), molybdenum (Mo), tungsten (W), rhenium (Re) and iridium (Ir).

Using a BF structure according to the invention an optical element becomes available which can be applied for wavelength selection, focusing and collimation of radiation in the wavelength range between 0.1 nm and 100 nm with an efficiency which is not achievable with a prior art multilayer structure without lateral pattern.

The invention further relates to an LMAG structure manufactured according to the above described method, wherein the multilayer structure comprises a stack of layers of a first material from a first group comprising boron (B), boron carbide (B₄C), carbon (C), silicon (Si) and scandium (Sc), and of layers of a second material from a second group comprising the materials from the groups of transition elements from the fourth, fifth and sixth period of the periodic system of elements.

In an embodiment of an LMAG structure according to the invention the multilayer structure is selected from the group comprising stacks of layers of tungsten and silicon (W/Si), tungsten and boron carbide (W/B₄C), molybdenum and boron carbide (Mo/B₄C), lanthanum and boron carbide (La/B₄C), chromium and carbon (Cr/C), iron and scandium (Fe/Sc), chromium and scandium (Cr/Sc), nickel and carbon (Ni/C) and nickel vanadium and carbon (NiV/C)

In an embodiment of a multilayer structure comprising a stack of layers of lanthanum and boron carbide (La/B₄C) the layers of lanthanum and boron carbide are separated by layers of lanthanum boride (LaB), these layers functioning as diffusion barrier.

Using an LMAG structure according to the invention an optical element becomes available which can be applied for wavelength selection, focusing and collimation of radiation in the wavelength range between 0.1 nm and 100 nm with an efficiency which is not achievable with a prior art multilayer structure without lateral pattern.

The invention will be elucidated hereinbelow on the basis of exemplary embodiments, with reference to the drawing.

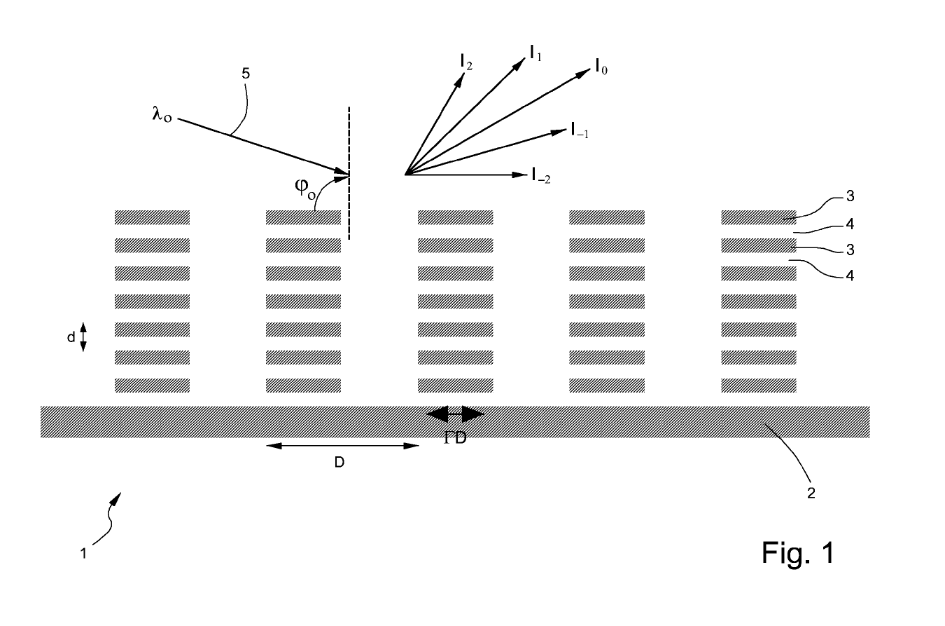

In the drawing FIG. 1 shows a schematic representation of the application of an LMAG structure 1 according to the invention as monochromator. LMAG structure 1 is formed by a substrate 2, for instance of SiO₂, having thereon a multilayer structure of thin layers 3, 4 stacked on each other with a layer period d, wherein according to the above described method a periodic lateral structure is arranged with a lateral period D and a line width ΓD. A beam of XUV radiation (represented by arrow 5) with a wavelength λ₀ is incident upon the surface of LMAG-structure 1 at an angle φ₀ to the surface of LMAG-structure 1. The incident beam is diffracted by LMAG-structure 1 in an exiting zeroth order beam I₀, first order beams I₁, I₋₁, second order beams I₂, I₋₂ and higher order beams (not shown).

It has been found that using an LMAG structure 1 according to the invention a monochromator can be provided which has a markedly lower dispersion (higher resolution) than with a flat, otherwise identical multilayer structure without lateral structure, wherein the reflectivity of the LMAG structure decreases to only slight extent compared to the reflectivity of the flat multilayer structure.

### EXAMPLE 1

An LMAG structure 1 according to FIG. 1 is constructed from a periodic stack of 120 layers 3 consisting of La (layer thickness 3.13 nm, roughness 0.38 nm) and layers 4 consisting of B₄C (layer thickness 5.05 nm, roughness 0.50 nm), with a lateral periodicity D=500 nm and a line width coefficient Γ=0.20, on a substrate 2 of Si. It is found that a beam of XUV radiation with a wavelength λ₀=6.7 nm, which is incident at an angle φ₀ upon the surface of LMAG structure 1, is reflected in zeroth order with a dispersion amounting to a factor 0.24 of the dispersion realized with an otherwise identical flat multilayer structure without lateral structure, wherein the reflectivity decreases by only 11% compared to this flat multilayer structure.

### EXAMPLE 2

An LMAG structure 1 according to FIG. 1 is constructed from a periodic stack of 150 layers 3 consisting of Cr (layer thickness 2.125 nm, roughness 0.312 nm) and layers 4 consisting of C (layer thickness 4.048 nm, roughness 0.338 nm), with a lateral periodicity D=300 nm and a line width coefficient Γ=0.33, on a substrate 2 of Si. It is found that a beam of XUV radiation with a wavelength λ₀=4.5 nm, which is incident at an angle φ₀ upon the surface of LMAG structure 1, is reflected in zeroth order with a dispersion amounting to a factor 0.34 of the dispersion realized with an otherwise identical flat multilayer structure without lateral structure, wherein the reflectivity decreases by only 5% compared to this flat multilayer structure.

### EXAMPLE 3

An LMAG structure 1 according to FIG. 1 is constructed from a periodic stack of 400 layers 3 consisting of W (layer thickness 0.715 nm, roughness 0.248 nm) and layers 4 consisting of Si (layer thickness 1.185 nm, roughness 0.384 nm), with a lateral periodicity D=400 nm and a line width coefficient Γ=0.25, on a substrate 2 of Si. A cover layer of SiO₂ with a thickness of 2 nm is applied to the structure (not shown in FIG. 1). It is found that a beam of XUV radiation with a wavelength λ₀=2.4 nm, which is incident at an angle φ₀ upon the surface of LMAG structure 1, is reflected in zeroth order with a dispersion amounting to a factor 0.25 of the dispersion realized with an otherwise identical flat multilayer structure without lateral structure, wherein the reflectivity decreases by only 15% compared to this flat multilayer structure.

1. Method for manufacturing a multilayer structure with a lateral pattern, in particular of an optical grating for application in an optical device for electromagnetic radiation with a wavelength in the wavelength range between 0.1 nm and 100 nm, comprising the steps of
(i) providing a multilayer structure, and
(ii) arranging a lateral three-dimensional pattern in the multilayer structure, characterized in that
step (ii) of arranging the lateral pattern is performed by means of a method for nano-imprint lithography (NIL).

2. Method as claimed in claim 1, wherein the method for nano-imprint lithography (NIL) comprises at least the steps of
(a) providing a stamp with a stamp pattern corresponding to the lateral three-dimensional pattern to be arranged,
(b) applying a layer of a curable resist material to the multilayer structure,
(c) arranging the stamp pattern, using the stamp, in the layer of resist material applied according to step (b), and curing this material, and
(d) removing from the multilayer structure material not, or at least substantially not covered by resist material in accordance with the stamp pattern while forming the lateral three-dimensional pattern in the multilayer structure.

3. Method as claimed in claim 2, wherein the removal of material according to step (d) is performed in accordance with a method for reactive ion etching (RIE).

4. Method as claimed in claim 2, wherein the removal of material in step (d) is performed by means of an inductively coupled plasma (ICP).

5. Method as claimed in claim 2, wherein the removal of material in step (d) is performed in accordance with a Bosch-type etching method.

6. Method as claimed in claim 2, wherein a form widening in wedge-shape from the surface of the multilayer structure is given to the lateral three-dimensional pattern to be formed in the multilayer structure in step (d).

7. Method as claimed in claim 2, wherein a form narrowing in wedge-shape from the surface of the multilayer structure is given to the lateral three-dimensional pattern to be formed in the multilayer structure in step (d).

8. Method as claimed in any of the claims 2-7, wherein the resist material to be applied according to step (b) is a UV-curable plastic which in cured state has a relatively low viscosity.

9. Method as claimed in any of the foregoing claims, wherein step (ii) of arranging the lateral pattern is followed by step (iii) of applying a cover layer over the three-dimensional pattern.

10. Multilayer structure with a periodic lateral pattern manufactured according to a method as claimed in any of the claims 1-9, characterized in that the period is smaller than 1 μm.

11. BF structure manufactured according to a method as claimed in any of the claims 1-9, characterized in that the multilayer structure comprises a stack of layers of a first material from a first group comprising carbon (C) and silicon (Si) and of layers of a second material from a second group comprising the materials from the groups of transition elements from the fourth, fifth and sixth period of the periodic system of elements.

12. BF structure as claimed in claim 11, characterized in that the layers of the second material are selected from the group of transition elements comprising cobalt (Co), nickel (Ni), molybdenum (Mo), tungsten (W), rhenium (Re) and iridium (Ir).

13. LMAG structure manufactured according to a method as claimed in any of the claims 1-9, characterized in that the multilayer structure comprises a stack of layers of a first material from a first group comprising boron (B), boron carbide (B₄C), carbon (C), silicon (Si) and scandium (Sc), and of layers of a second material from a second group comprising the materials from the groups of transition elements from the fourth, fifth and sixth period of the periodic system of elements.

14. LMAG structure as claimed in claim 13, characterized in that the multilayer structure is selected from the group comprising a stack of layers of tungsten and silicon (W/Si), tungsten and boron carbide (W/B₄C), molybdenum and boron carbide (Mo/B₄C), lanthanum and boron carbide (La/B₄C), chromium and carbon (Cr/C), iron and scandium (Fe/Sc), chromium and scandium (Cr/Sc), nickel and carbon (Ni/C) and nickel vanadium and carbon (NiV/C).

15. LMAG structure as claimed in claim 14, wherein the multilayer structure comprises a stack of layers of lanthanum and boron carbide (La/B₄C), characterized in that the layers of lanthanum and boron carbide are separated by layers of lanthanum boride (LaB).
